(19) United States
(12) Patent Application Publication
(10) Pub. No.: US 2009/0309827 A1
(43) Pub. Date: Dec. 17, 2009

(54) METHOD AND APPARATUS FOR AUTHORING TACTILE INFORMATION, AND COMPUTER READABLE MEDIUM INCLUDING THE METHOD

(75) Inventors: Je-Ha Ryu, Gwangju (KR); Yeong-Mi Kim, Gwangju (KR); Jong-Eun Cha, Gwangju (KR); Yong-Won Seo, Gwangju (KR)

Correspondence Address: AMPACC LAW GROUP, 3500 188th St. SW, Lynnwood, WA, 98037, US

(73) Assignee: Gwangiu Institute of Science and Technology, Gwangiu (KR)

(21) Appl. No.: 12/303,367

(22) PCT Filed: Feb. 29, 2008
(86) PCT No.: PCT/KR08/01199

§ 371 Date: Dec. 3, 2008

(30) Foreign Application Priority Data
Mar. 2, 2007 (KR) 10 2007 0020930

(51) Int. Cl. G09G 5/00; H04N 5/91

(52) U.S. Cl. 345/156; 386/83

(57) ABSTRACT

The present invention relates to a method and apparatus for authoring tactile information that generates a tactile video for representing tactile information in the form of an intensity value of a pixel in order to author tactile information. More particularly, the present invention relates to a method and apparatus for authoring tactile information that represents an intensity value of a pixel of a tactile video in a drawing manner on a tactile video input window while outputting and referring to audiovisual media. The present invention provides an apparatus for authoring a tactile video that represents information about driving strength of an actuator array of a tactile display apparatus in the form of an intensity value of a pixel. The apparatus includes a tactile video generating unit that including a configuration module and a tactile video authoring module. The configuration module performs configuration to author a tactile video. The tactile video authoring module includes a video clip playback window that outputs information about audiovisual media, such as a video clip or a text, becoming a base of authoring the tactile video by frames, and a tactile video input window to which an intensity value of each of pixels of the tactile video is input in a drawing manner. The tactile video is generated by frames.

### TECHNICAL FIELD

The present invention relates to a method and apparatus for authoring tactile information that generates a tactile video for representing tactile information in the form of an intensity value of a pixel in order to author tactile information. More particularly, the present invention relates to a method and apparatus for authoring tactile information that represents an intensity value of a pixel of a tactile video in a drawing manner on a tactile video input window while outputting and referring to audiovisual media.

### BACKGROUND ART

Human beings recognize the surrounding environment using the five senses, such as sight, hearing, smell, state, and touch. Among the five senses, the human being mainly depends on the senses of sight and hearing to acquire information on the surrounding environment. However, in many cases, actually, the human being depends on tactile information to acquire information on the surrounding environment. The sense of touch is used to determine the position, shape, texture, and temperature of an object. Therefore, it is necessary to provide tactile information as well as visual information and auditory information in order to transmit realistic feeling. Therefore, in recent years, haptic technology for providing tactile information together with visual information and auditory information to enable the user to directly interact with a scene on the screen in the fields of education, training, and entertainment has drawn great attention.

The haptic technology provides various information of the virtual or actual environment to the user through tactile feeling and kinesthetic feeling. The term ‘haptic’ is the Greek language meaning the sense of touch, and includes the meaning of tactile feeling and kinesthetic feeling. The tactile feeling provides information on the geometrical shape, roughness, temperature, and texture of a contact surface through skin sensation, and the kinesthetic feeling provides information on a contact force, flexibility, and weight through the propriocetive sensation of muscle, bone, and joint.

In order to provide the tactile information to the user, the following processes are needed: a process of acquiring tactile information; a process of editing or synthesizing the tactile information with, for example, image information; a process of transmitting the edited tactile information and image information; and a process of playing back the transmitted tactile information and image information.

Meanwhile, a kinesthetic display apparatus, such as the PHANToM™ made by SensAble Technologies, Inc., has been generally used to provide haptic information. The kinesthetic display apparatus can display the texture, friction, and shape of a virtual object using a motor or a mechanical structure, such as an exo-skeletal structure. However, the kinesthetic display apparatus is incapable of directly providing information on the skin of the user, and the end-effect of the kinesthetic display apparatus is provided to the user by a pen or a thimble for feeling force. The kinesthetic display apparatus is expensive.

A tactile display apparatus, which directly acts on the skin of a human body, may be used other than the above-mentioned kinesthetic display apparatus. The tactile display apparatus is formed of the combination of actuators, and each of the actuators may be a vibrotactile stimulation type or a pneumatic tactile stimulation type. The actuator of the vibrotactile stimulation type may be composed of an eccentric motor or a piezoelectric element.

A process for authoring or editing information to drive each of the actuators is required in the case of the tactile display apparatus that is formed of the combination of actuators. This process should be synchronized with image information. However, since a tool used to create tactile contents for the tactile display apparatus has not been provided in the related art, there is a problem in that it is difficult to author or edit tactile information.

Meanwhile, social interest in UCC (User Generated Contents) is being increased. For example, Youtube (http://www.youtube.com), which provides various UCC services, such self-expression, advertisement effect, and education, through the internet, was selected as Invention of the Year in 2006 by Times. However, audiovisual video clips or texts were created as most UCC that have created until now.

For this reason, there is a demand for developing a tactile information editing tool that authors and edits tactile information synchronized with audiovisual media information and can effectively represent the tactile information on the basis of the authoring and edition.

### DISCLOSURE OF INVENTION

### Technical Problem

In order to solve the above-mentioned problem, an object of the prevent invention is to provide an apparatus for authoring a tactile video that generates a tactile video for representing driving strength of an actuator array of a tactile display apparatus in the form of an intensity value of a pixel on the basis of audiovisual media in a drawing manner.

Further, another object of the present invention is to provide a method of authoring tactile information that generates a window where audiovisual media are output and a tactile video is input, and generates a tactile video in a drawing manner, and a computer readable recording medium on which the method is recorded.

### Technical Solution

In order to achieve the above-mentioned object, according to an embodiment of the present invention, an apparatus for authoring a tactile video represents information about driving strength of an actuator array of a tactile display apparatus in the form of an intensity value of a pixel. The apparatus includes a tactile video generating unit that includes a configuration module and a tactile video authoring module. The configuration module performs configuration to author a tactile video. The tactile video authoring module includes a video clip playback window that outputs information about audiovisual media, such as a video clip or a text, becoming a base of authoring the tactile video by frames, and a tactile video input window to which an intensity value of each of pixels of the tactile video is input in a drawing manner. The tactile video is generated by frames.

The apparatus for authoring tactile information may further include a tactile video storage unit that stores the tactile video, and a binary format for scenes generating unit that generates a binary format for scenes for describing a time relationship between the audiovisual media and the tactile video.

Further, the apparatus for authoring tactile information may further include a file generating unit that encodes the audiovisual media, the tactile video, and the binary format for scenes, thereby generating one file.

According to another embodiment of the present invention, a method of authoring a tactile video represents information about driving strength of an actuator array of a tactile display apparatus in the form of an intensity value of a pixel. The method includes a step (a) of performing configuration, which includes the setting of the size of the tactile video, audiovisual media becoming a base of the tactile video, and a frame rate of the tactile video, to author a tactile video; a step (b) outputting information about the audiovisual media to a video clip playback window by frames, and generating a tactile video input window on which the tactile video is authored; and a step (c) of inputting an intensity value of each pixel of the tactile video to the tactile video input window in a drawing manner by an input device.

### Advantageous Effects

As described above, according to the present invention, it is possible to obtain an advantage of generating a tactile video, which represents driving strength of an actuator array of a tactile display apparatus, in such a manner that a picture is drawn on the basis of audiovisual media.

Further, according to the present invention, an interface, which is used to conveniently generate a tactile video, is provided to a user, an inputting method is simple, and a tactile video is easily stored. Therefore, there is an advantage in that a user can personally author tactile information in a simple manner.

### BRIEF DESCRIPTION OF THE DRAWINGS

FIG. 1 is a view showing an example of a tactile display apparatus that plays back tactile information generated using a method of authoring tactile information according to a preferred embodiment of the present invention.

FIG. 2 is a view showing an actuator array of a tactile display apparatus shown in FIG. 1 and a tactile video corresponding to the actuator array.

FIG. 3 is a block diagram of an apparatus for authoring tactile information according to a preferred embodiment of the present invention.

FIG. 4 is a block diagram showing the detailed structure of a tactile video generating unit of the apparatus for authoring tactile information according to the preferred embodiment of the present invention.

FIG. 5 is a view showing an interface of the tactile video generating unit of the apparatus for authoring tactile information according to the preferred embodiment of the present invention.

FIG. 6 is a view showing that tactile information is input using the interface of the tactile video generating unit of the apparatus for authoring tactile information according to the preferred embodiment of the present invention.

FIG. 7 is a view showing a tactile video frame generated in FIG. 6.

FIG. 8 is a diagram illustrating an example of the MovieTexture node of the binary format for scenes in the MPEG-4 standard.

FIG. 9 is a diagram illustrating the TactileDisplay node for representing tactile information according to the embodiment of the present invention.

FIG. 10 is a diagram illustrating a process of connecting the TactileDisplay node and the MovieTexture node to define a tactile video object according to the embodiment of the present invention.

FIG. 11 is a view showing a TactileDisplayTexture node that is used to represent tactile information in the preferred embodiment of the present invention.

FIG. 12 is a flowchart illustrating a method of authoring tactile information according to a preferred embodiment of the present invention.

### BEST MODE FOR CARRYING OUT THE INVENTION

Hereinafter, exemplary embodiments of the present invention will be described in detail with reference to the accompanying drawings. First, it will be noted that the same components are denoted by the same reference numerals, even though the components are shown in different drawings. In the embodiments of the present invention, a detailed description of known device structures and techniques incorporated herein will be omitted when it may make the subject matter of the present invention unclear. The present invention may, however, be embodied in many different forms and should not be construed as being limited to the embodiments set forth herein. Rather, these embodiments are provided so that this disclosure will be thorough and complete and will fully convey the concept of the present invention to those skilled in the art, and the present invention will only be defined by the appended claims.

A method and apparatus for authoring tactile information according to the present invention author and edit tactile information about actuators of a tactile display apparatus that is formed by the combination of the actuators in the form of an array. The drive of each of the actuators of the tactile display apparatus can be controlled by specifying the drive time and strength of each of the actuators. In the present invention, the driving strength of the actuator array, which is formed by the combination of the actuators, is generated in the form of a tactile video.

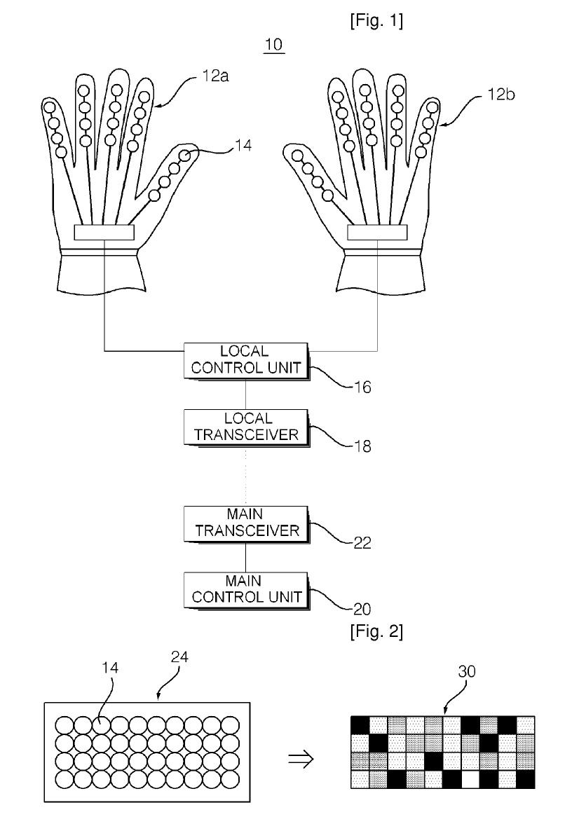

FIG. 1 is a view showing an example of a tactile display apparatus that plays back tactile information generated using a method of authoring tactile information according to a preferred embodiment of the present invention. FIG. 2 is a view showing an actuator array of a tactile display apparatus shown in FIG. 1 and a tactile video corresponding to the actuator array.

A tactile display apparatus 10 includes tactile display units 12a and 12b each having a plurality of actuators 14, a local control unit 16 that controls the actuators 14, and a local transceiver 18 that transmits/receives control signals for controlling the actuators 14 and transmits the control signals to the local control unit 16. The tactile display apparatus 10 further includes a main control unit 20 that generates the control signals for controlling the actuators 14 and a main transceiver 22 that transmits the control signals generated by the main control unit 20 to the local transceiver 18 of the tactile display apparatus 10.

The main control unit 20 generates the control signals for controlling the actuators 14 and transmits the control signals to the local control unit 16 through the main transceiver 22 and the local transceiver 18. The local control unit 16 controls the driving of the actuators 14 on the basis of the control signals. The main transceiver 22 and the local transceiver 18 may be connected to each other by cables or a wireless communication link, such as Bluetooth.

In FIG. 1, the tactile display units 12a and 12b are implemented in glove shapes such that the user can put on the gloves, but the present invention is not limited thereto. The tactile display units 12a and 12b may be implemented in various shapes. The tactile display units 12a and 12b may be implemented in any shapes other than the glove shapes that can be worn on the user's head, arm, leg, back, or waist, such as in shoe shapes or hat shapes.

The actuators 14 provided in the tactile display units 12a and 12b may be a vibrotactile stimulation type or a pneumatic tactile stimulation type. The actuator 14 of the vibrotactile stimulation type may be composed of an eccentric motor or a piezoelectric element. The actuator 14 of the pneumatic tactile stimulation type may be composed of a nozzle that supplies air.

It is possible to control the driving of each of the actuators 14 by specifying driving strength. Therefore, it is possible to display tactile information to the user by transmitting information on the driving strength of each of the actuators 14 through the local control unit 16. The main control unit 20 transmits the information on the driving strength of each of the actuators 14 to the local control unit 16. In the present invention, information on the driving strength of each of the actuators 14 is transmitted in the form of a tactile video to the main control unit 20, and the main control unit converts each pixel value into driving strength whenever each frame of the tactile video is changed, and transmits the driving strength to the control unit 16.

The tactile video will be described with reference to FIG. 2.

In FIG. 1, the left tactile display unit 12a and the right tactile display unit 12b each include 4 by 5 actuators 14, that is, a 4-by-10 actuator array 24 is provided. That is, a combination of the actuators 14 shown in FIG. 2 can be represented by a rectangular array. A tactile video 30 is composed of pixels corresponding to the actuators 14.

Each of the pixels of the tactile video 30 includes intensity information of the pixel, and the intensity information corresponding to the driving strength of the actuator corresponding to the pixel. When the tactile video 30 is represented by a black and white video with grayscale levels, each pixel has intensity information in the range of 0 to 255, and the actuators are driven on the basis of the intensity information. For example, an actuator corresponding to a white pixel is strongly driven, and an actuator corresponding to a black pixel is weakly driven.

When the actuator array 24 of the tactile display apparatus 10 corresponds one-to-one to the pixels of the tactile video 30, the intensity information of the pixels correspond one-to-one with the driving strengths of the actuators. However, when the dimension of the tactile video 30 is larger than that of the actuator array 24, mapping therebetween is performed according to the ratio between the dimensions. For example, when the tactile video 30 has a dimension of 320×240 and the actuator array 24 of the tactile display apparatus 10 has a dimension of 10×4, the size of the tactile video 30 is adjusted from 320 by 240 pixels to 10 by 4 pixels such that the tactile video 30 corresponds one-to-one with the actuator array 24. In this case, the intensity information of the tactile video 30 having the adjusted size is obtained by averaging the intensity information of the pixels before the size adjustment.

Since the format of the tactile video 30 is the same as that of a general color or black and white video, the tactile video can be transmitted by general video encoding and decoding methods. In addition, the tactile video 30 is composed of a plurality of frames, and the intensity information of the pixels in each frame corresponds to the driving strength of each of the actuators in the tactile display apparatus 10.

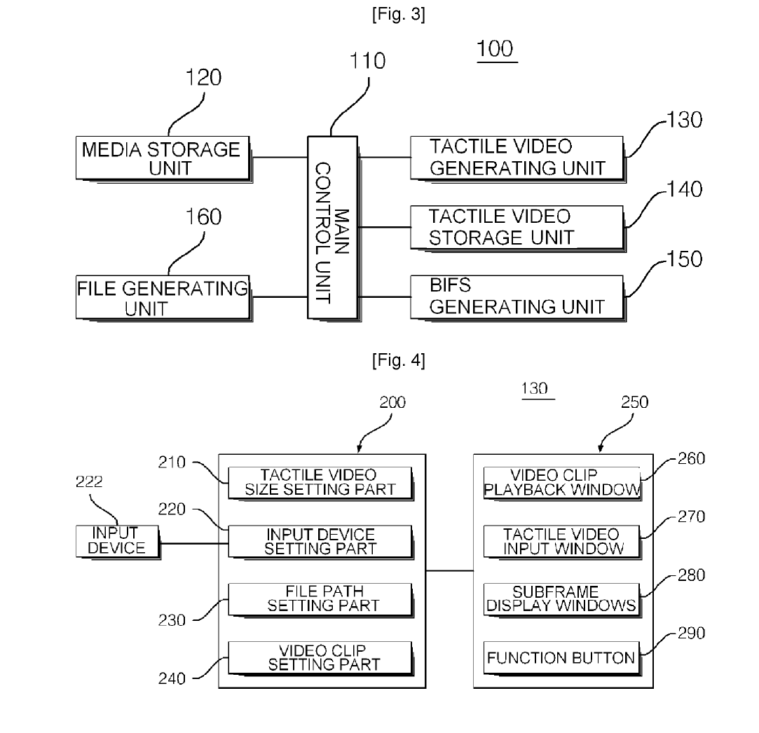

FIG. 3 is a block diagram of an apparatus for authoring tactile information according to a preferred embodiment of the present invention.

An apparatus 100 for authoring tactile information according to a preferred embodiment of the present invention includes a main control unit 110 that controls the functions of components overall, a media storage unit 120 that stores audiovisual media such as video clips or texts, a tactile video generating unit 130 that generates tactile videos, a tactile video storage unit 140 that stores the generated tactile videos, and a binary format for scenes generating unit 150 that generates a binary format for scenes representing a time relationship between the tactile videos and media information such as videos or audios.

The apparatus 100 for authoring tactile information according to the preferred embodiment of the present invention may further include a file generating unit 160. The file generating unit encodes the tactile videos generated by the tactile video generating unit 130, the audiovisual media, and the binary format for scenes describing the relationship therebetween, thereby generating one file such as an MP4 file. In particular, in the present invention, the tactile videos are generated so that each of pixels corresponds to each of the actuators 14 of the actuator array 24 of the tactile display apparatus 10. Since having the same format as a general black-and-white or color video, the tactile videos can be encoded by a common video encoding method. Accordingly, the file generated by the file generating unit 160 may be generated by an encoding method and a multiplexing method that are used in the MPEG-4 standard.

The tactile video generating unit 130 generates tactile videos including tactile information on the basis of the media information stored in the media storage unit 120. The tactile video generating unit 130 loads the media information from the media storage unit 120 by frames, generates tactile information of corresponding frames, and then stores the tactile information in the form of tactile videos. The detailed configuration of the tactile video generating unit 130 will be described below.

The tactile video storage unit 140 stores the tactile videos generated by the tactile video generating unit 130. The tactile videos are stored in the form of a general video.

The binary format for scenes generating unit 150 generates a binary format for scenes that describes the time relationship between the media information and the tactile videos. The binary format for scenes is represented by a binary format for scenes (BIFS) in the case of the MPEG-4 standard.

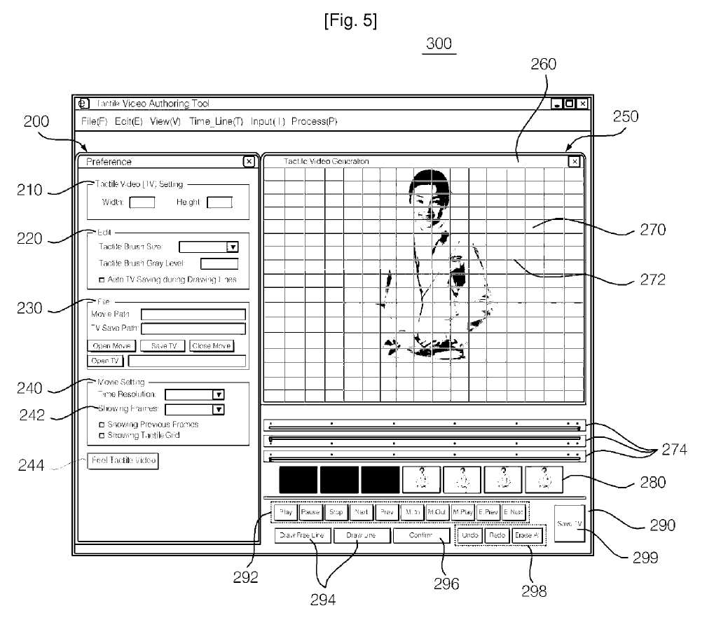

FIG. 4 is a block diagram showing the detailed structure of a tactile video generating unit of the apparatus for authoring tactile information according to the preferred embodiment of the present invention, and FIG. 5 is a view showing an interface of the tactile video generating unit of the apparatus for authoring tactile information according to the preferred embodiment of the present invention.

An interface 300 of the tactile video generating unit, which is shown in FIG. 5, exemplifies that the tactile video generating unit 130 of the apparatus 100 for authoring tactile information according to the preferred embodiment of the present invention is actually embodied. The configuration of the tactile video generating unit 130 will be described hereinafter with reference to FIGS. 4 and 5.

The tactile video generating unit 130 includes a configuration module 200 and a tactile video authoring module 250.

The configuration module 200 sets the size of a tactile video, an input device that generates a tactile video, a video clip that is an object of the generation of the tactile video, the number of frames of the tactile video, and the like. Meanwhile, the tactile video authoring module 250 outputs a video clip for each frame to a video clip playback window 260 according to the configuration of the configuration module 200, and makes tactile information be input or edited by a tactile video input window 270. This will be described in detail hereinafter.

The configuration module 200 includes a tactile video size setting part 210, an input device setting part 220, a file path setting part 230, and a video clip setting part 240.

The tactile video size setting part 210 sets the size of a tactile video. The size of the tactile video is set by inputting the numbers of pixels corresponding to length and breadth. The pixels of the tactile video correspond to the actuators of the tactile display apparatus 10, respectively. Accordingly, the size of the tactile video is set to correspond to the dimension of the actuator array of the tactile display apparatus 10. However, the pixels of the tactile video do not necessarily need to correspond to the actuators of the tactile display apparatus 10 one by one. If the number of the pixels of the tactile video is larger than that of the actuators of the tactile display apparatus 10, the pixels may match with the actuators at a predetermined ratio.

The input device setting part 220 sets the input device 222 that is used to input tactile information. Since the tactile information is represented by the intensity (that is, grayscale level) of each pixel of each tactile video, the tactile video may be generated in such a manner that a picture is drawn by a kind of drawing tool. Therefore, the input device 222 may be a keyboard, a mouse, a tablet pen, or the like. When a mouse or a keyboard is used, it is possible to input tactile information to the each pixel by using a drawing function or a filling function that corresponds to a predetermined intensity. If a grayscale level is set to 128 and a specific pixel is then filled with corresponding color or a line drawing is performed, the intensity value of the specific pixel is set to 128. Meanwhile, a tablet pen may be used as another input device. In this case, the intensity value of each may be set in accordance with the input pressure of the tablet pen. The input device setting part 220 of FIG. 5 is an example where the intensity value of a pixel is input using a mouse and a grayscale level and the thickness of a brush can be set by the mouse during the inputting.

The file path setting part 230 sets a storage path of a video clip of which tactile video is to be generated and stores the generated tactile video, or sets a storage path of the generated tactile video to read a video clip or store the generated tactile video. Accordingly, a user can author a new tactile video on the basis of the video clip, or load and edit the generated tactile video.

The video clip setting part 240 determines a frame rate (time resolution) of a tactile video. A video clip is generally played back by 30 frames per second. A tactile video may be generated in every video clip frame, and one tactile video frame may be generated per some video clip frames. For this purpose, the video clip setting part 240 determines for how many video clip frames one tactile video frame is generated. In addition, a subframe setting part 242 sets how many video clips, which are provided before and after the video clip frame that is currently generating a tactile video, are represented.

Meanwhile, the tactile video generating unit 130 may further include a tactile playback button 244. The tactile playback button 244 is used to play back the generated tactile video on the tactile display apparatus 10 by frames or predetermined time periods. Therefore, a user actually feels the tactile video, which has been edited or authored, by the tactile display apparatus 10, and can then easily correct the tactile video. When a user operates the tactile playback button 244, the main control unit 110 sends the tactile video to the main control unit 20 of the tactile display apparatus 10 and the main control unit 20 controls the actuator 14 on the basis of the pixel information of the tactile video frame so that the actuator provides tactile sensation to a user.

The detailed configuration of the tactile video authoring module 250 of the tactile video generating unit 130 will be described hereinafter.

The tactile video authoring module 250 includes a video clip playback window 260, a tactile video input window 270, and various function buttons 290.

The video clip playback window 260 is a window on which a video clip is displayed, and a video clip is played back by frames.

The tactile video input window 270 is a window to which intensity information about each pixel of the tactile video is input. The intensity information about each pixel, for example, information about a grayscale level may be input by a drawing or filling function using a mouse or a keyboard as described above, and may be input by the input pressure of a tablet pen. Further, grid lines 272, which divide the pixels of the tactile video, are preferably represented or omitted on the tactile video input window 270.

The video clip playback window 260 and the tactile video input window 270 may be formed of separate windows, respectively. However, the video clip playback window 260 and the tactile video input window 270 may overlap each other to be displayed as one window. In FIG. 5, the video clip playback window 260 and the tactile video input window 270 are displayed as one window. In this case, the tactile video input window is made transparent, and overlaps the video clip. Meanwhile, slide bars 274 may be provided to improve user's convenience, such as to change the frame of the video clip playback window 260 into another frame thereof or to designate a pre-determined range.

Subframe display windows 280 display video clip frames, which serve as reference screens for generating tactile videos, on small screens. Accordingly, a user can confirm the position of the frame, which is being edited now.

The various function buttons 290 of the tactile video authoring module 250 will be described below.

An operation button 292 sequentially includes buttons that perform functions corresponding to Play, Pause, Stop, representation of next frame (Next), and representation of previous frame (Prev).

Drawing setting buttons 294 are used to select options that perform drawing on the tactile video input window 270 by a mouse or the like. The generation of a free line (Draw Free Line) or the generation of a line (Draw Line) may be inputted. Although not shown, other options that fill pixels and input spots may be added.

When a tactile video of a frame is completely input, a confirm button 296 is used to store corresponding tactile video frame in a buffer.

Auxiliary input buttons 298 provide functions corresponding to the release of input (Undo), the restoration of the deleted items (Redo), the erasure of all items (Erase All), the erasure of input (Erase), and the like so that items input using a mouse can be deleted or restored.

A store button 299 is used to finally store the completed tactile video.

The tactile video generated by the tactile video generating unit 130 is stored in the tactile video storage unit 140 through the operation of the store button 299. Meanwhile, the binary format for scenes generating unit 150 generates information, which is used for the synchronization output of a tactile video and a video clip, and stores the information as binary format for scenes information.

An example where a tactile video is generated using the above-mentioned tactile video generating unit 130 will be described.

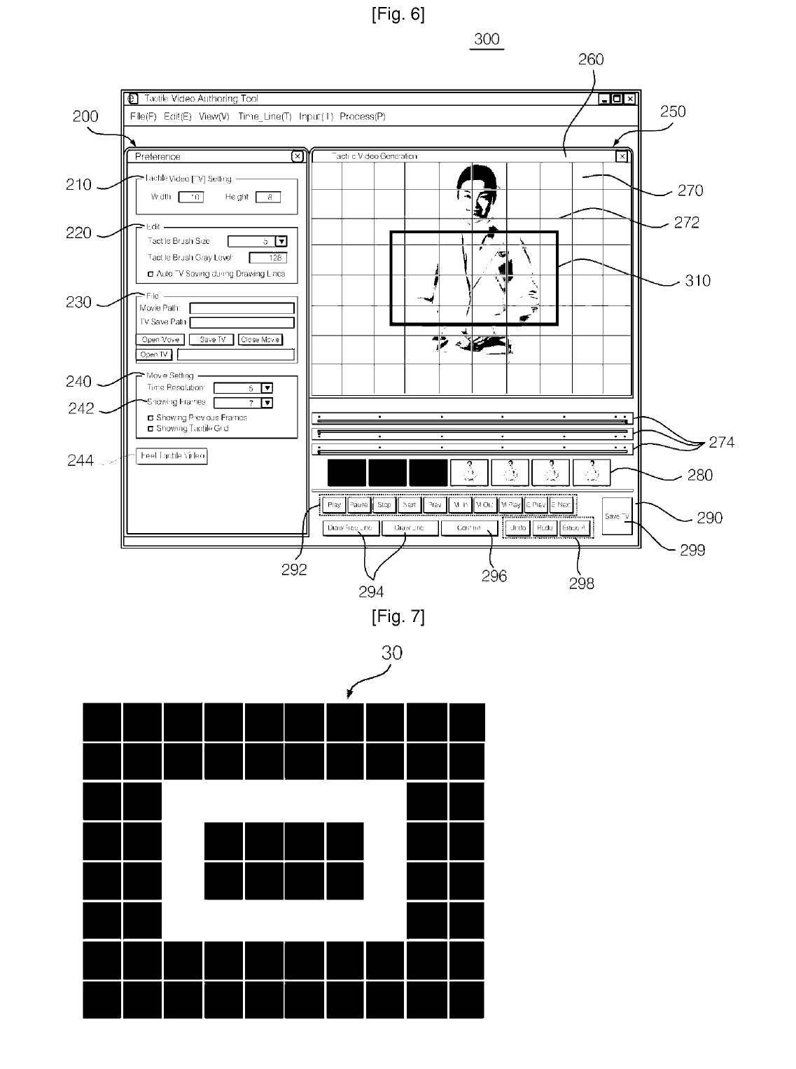

FIG. 6 is a view showing that tactile information is input using the interface of the tactile video generating unit of the apparatus for authoring tactile information according to the preferred embodiment of the present invention, and FIG. 7 is a view showing a tactile video frame generated in FIG. 6.

Referring to FIG. 6, 10 and 8 were input to the tactile video size setting part 210 as the numbers of pixels corresponding to length and breadth, so that a 10 by 8 tactile video input window 270 was generated. Further, after the thickness of a brush was set to 5 and a grayscale level was set to 128 in the input device setting part 220, a line was drawn on the tactile video input window 270 by a mouse. 5 was input to the video clip setting part 240 as a frame rate of a tactile video so that one frame of a tactile video was generated in every five frames. Further, 7 was input as a set value of a subframe so that seven frames were represented on the subframe display windows 280.

Accordingly, a tactile video 30 was generated as shown in FIG. 7. The generated tactile video 30 was obtained by drawing the line on tactile video input window 270 with the grayscale level of 128 in FIG. 6, and the pixels on which the line was drawn has the grayscale level of 128.

When using the tactile generating unit 130 of the above-mentioned apparatus 100 for authoring tactile information according to the present invention, a user can generate or edit the frames of tactile videos in such a simple manner that a common drawing tool is used.

Meanwhile, the generated tactile videos can be loaded again and then edited. When a tactile video of another video clip video is generated, the generated tactile videos may be used. In particular, the generated tactile videos are stored for each pattern so as to correspond to specific images or sound and are used later, so that it is possible to maximize the convenience in authoring a tactile video.

The generation of the binary format for scenes, which synchronizes the tactile video generated by the tactile video generating unit 130 with media such as video clips, will be described in detail below. As described above, the binary format for scenes generating unit 150 generates the binary format for scenes that describes the time relationship between the tactile video and the media. The node structure of the binary format for scenes, which describes the tactile video, is newly defined, so that the tactile video and media information can be encode as one file.

An MPEG-4 standard transmits information for representing an object through a plurality of elementary streams (ES). The mutual relation between the elementary streams (ES) and information on the configuration of a link are transmitted by object descriptors defined by the MPEG-4 standard. In general, an initial object descriptor (IOD), a binary format for scenes (BIFS), an object descriptor, and media data are needed to form a scene on the basis of the MPEG-4 standard. The initial object descriptor (IOD) is information to be transmitted first in order to form an MPEG-4 scene. The initial object descriptor describes the profile and the level of each medium, and includes elementary stream (ES) descriptors for a BIFS (binary format for scenes) stream and an object descriptor stream.

The object descriptor is a set of elementary stream descriptors that describe information of media data forming the scene, and connects the elementary streams (ES) of the media data and the scene. The binary format for scenes (BIFS) is information that describes the temporal and spatial relationships between the objects.

In the MPEG-4 standard, the binary format for scenes BIFS includes a MovieTexture node that defines a video object.

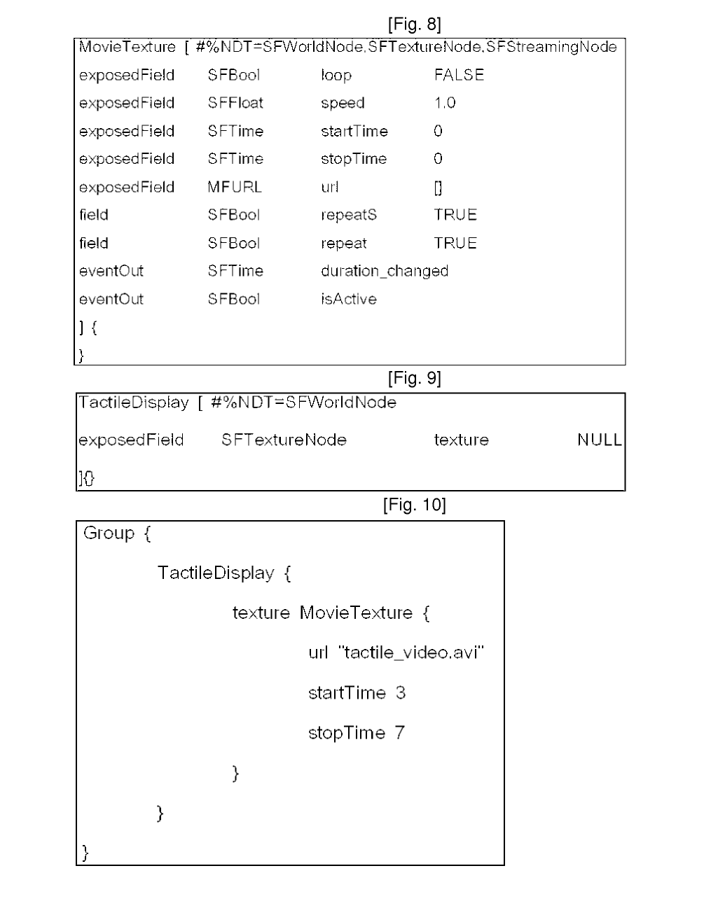

FIG. 8 is a diagram illustrating an example of the MovieTexture node of the binary format for scenes in the MPEG-4 standard.

In the MovieTexture node shown in FIG. 8, “startTime” indicates a video start time, and “stopTime” indicates a video stop time. In this way, it is possible to synchronize a video with another object. In addition, “url” sets the position of a video.

In the present invention, a TactileDisplay node is defined in order to transmit a tactile video using the MovieTexture node of the binary format for scenes.

FIG. 9 is a diagram illustrating the TactileDisplay node for representing tactile information according to the embodiment of the present invention. FIG. 10 is a diagram illustrating a process of connecting the TactileDisplay node and the MovieTexture node to define a tactile video object according to the embodiment of the present invention.

FIG. 9 shows that the TactileDisplay node is a kind of texture node. In FIG. 10, a “url” field indicates the position of a tactile video, a “startTime” field indicates a start time, and a “stopTime” field indicates a stop time. That is, the MovieTexture node is connected to the texture field of the TactileDisplay node to define a tactile video object. In FIG. 10, the tactile video set as “tactile_video.avi” is played back for four seconds by the tactile display apparatus three seconds after a play start instruction is input.

In FIGS. 9 and 10, the TactileDisplay node is defined as a kind of texture node, and the existing MovieTexture node is used to represent a tactile video object. However, the TactileDisplay node may be defined as a new texture node as follows.

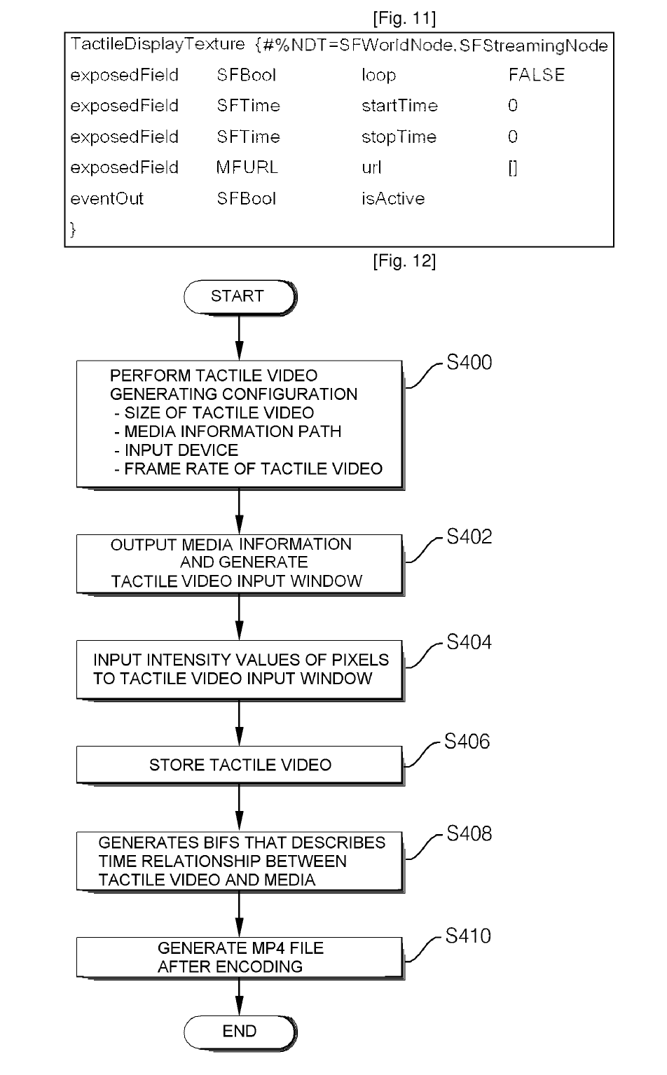

FIG. 11 is a diagram illustrating a TactileDisplayTexture node for representing tactile information according to an embodiment of the present invention.

Referring to FIG. 11, in the binary format for scenes (BIFS) of the MPEG-4 standard, a TactileDisplayTexture node for transmitting a tactile video is newly defined. “TactileDisplayTexture” defines the play start time and the play stop time of a tactile video file, and a “url” field indicates the position of the tactile video file.

A method of authoring tactile information will be described below.

FIG. 12 is a flowchart illustrating a method of authoring tactile information according to a preferred embodiment of the present invention.

In order to author tactile information, a user performs configuration to generate a tactile video (S400). For the tactile video generating configuration, the size of a tactile video, a path of media information such as a video clip that is an object of the generation of the tactile video, an input device that generates a tactile video, a frame rate of a tactile video, and the like need to be set by the configuration module 200.

In accordance with the setting of the configuration module 200, media information is output by frames to the video clip playback window 260 of the tactile video authoring module 250, and a tactile video input window 270 is generated (S402). If the configuration module 200 loads the generated tactile video, the frames of the generated tactile video are outputted to the tactile video input window 270.

The intensity values are generated or corrected on the pixels of the tactile video input window 270 depending on the information input by the input device (S404).

The frames of the tactile video are temporarily stored in a buffer when the tactile information (that is, an intensity value of each of the pixels) of corresponding tactile video frame is completely input, and the tactile video is stored in the tactile video storage unit 140 when an operation is completed (S406).

Meanwhile, the binary format for scenes generating unit 150 generates a binary format for scenes that describes the time relationship between the tactile video and media information (S408). A texture node, which includes the position field of a tactile video and fields representing the playback start time and playback stop time as described above, is included and generated in the binary format for scenes.

For the last time, the file generating unit 160 encodes and multiplexes the tactile video, the media information, and the binary format for scenes information, thereby forming one file such as an MP4 file (S410).

Although the present invention has been described in connection with the exemplary embodiments of the present invention, it will be apparent to those skilled in the art that various modifications and changes may be made thereto without departing from the scope and spirit of the present invention. Therefore, it should be understood that the above embodiments are not limitative, but illustrative in all aspects. The scope of the present invention is defined by the appended claims rather than by the description preceding them, and all changes and modifications that fall within meets and bounds of the claims, or equivalences of such meets and bounds are therefore intended to be embraced by the claims.

1. An apparatus for authoring a tactile video that represents information about driving strength of an actuator array of a tactile display apparatus in the form of an intensity value of a pixel, the apparatus comprising:
a tactile video generating unit that includes a configuration module and a tactile video authoring module, the configuration module performing configuration to author a tactile video, the tactile video authoring module including a video clip playback window that outputs information about audiovisual media, such as a video clip or a text, becoming a base of authoring the tactile video by frames, and a tactile video input window to which an intensity value of each of pixels of the tactile video is input in a drawing manner,
wherein the tactile video is generated by frames.

2. The apparatus of claim 1,
wherein the configuration module further includes:
a tactile video size setting part that sets the size of a frame of the tactile video displayed on the tactile video input window;
an input device setting part that sets an input device for inputting tactile information to the tactile video input window; and
a video clip setting part that determines a frame rate of the tactile video.

3. The apparatus of claim 2,
wherein the input device setting part sets the intensity values of the pixels so that the intensity values are input by a mouse or a keyboard, or sets the intensity values of the pixels so that the intensity values are input by input pressure of a tablet pen.

4. The apparatus of claim 2,
wherein the configuration module further includes a file path setting part that sets information about paths of the audiovisual media and the tactile media.

5. The apparatus of claim 1,
wherein the video clip playback window and the tactile video input window are output so as to overlap each other.

6. The apparatus of claim 1,
wherein the tactile video authoring module further includes a subframe display window that displays previous and next frames of the frame output to the video clip playback window, and
the video clip setting part includes a subframe setting part that sets the number of frames to be output to the subframe display window.

7. The apparatus of claim 1,
wherein since the tactile video generating unit includes a tactile playback button, the tactile video is sent to the tactile display apparatus and tactile sensation is displayed when the tactile playback button is operated.

8. The apparatus of claim 1,
wherein the tactile video authoring module is provided with function buttons that include an operation button for controlling the output of the frame displayed on the video clip playback window, drawing setting buttons for setting a drawing function input to the tactile video input window by the input device, auxiliary input buttons for changing the input state of the input device, and a confirm button for confirming the input of the tactile video.

9. The apparatus of claim 1, further comprising:
a media storage unit that stores the audiovisual media;
a tactile video storage unit that stores the tactile video generated by the tactile video generating unit; and
a binary format for scenes generating unit that generates a binary format for scenes for describing a time relationship between the audiovisual media and the tactile video generated on the basis of the audiovisual media.

10. The apparatus of claim 9,
wherein the binary format for scenes includes a node including a url field that indicates the position of the tactile video, a startTime field that indicates a start time of the tactile video, and a stopTime field that indicates a stop time of the tactile video.

11. The apparatus of claim 9, further comprising:
a file generating unit that encodes the audiovisual media, the tactile video, and the binary format for scenes, thereby generating one file.

12. A method of authoring a tactile video that represents information about driving strength of an actuator array of a tactile display apparatus in the form of an intensity value of a pixel, the method comprising the steps of:
(a) performing configuration, which includes the setting of the size of the tactile video, audiovisual media becoming a base of the tactile video, and a frame rate of the tactile video, to author a tactile video;
(b) outputting information about the audiovisual media to a video clip playback window by frames, and generating a tactile video input window on which the tactile video is authored; and
(c) inputting an intensity value of each pixel of the tactile video to the tactile video input window in a drawing manner by an input device.

13. The method of claim 12,
wherein in the step (c), the intensity value is input to the tactile video input window in the form of a point, a line, and a surface having a predetermined intensity value by a mouse or a keyboard or is input by the input pressure of a tablet pen.

14. The method of claim 12,
wherein in step (b), the video clip playback window and the tactile video input window are output to overlap each other

15. The method of claim 12, further comprising the steps of:
(d) storing the authored tactile video; and
(e) generating a binary format for scenes that describes a time relationship between the audiovisual media and the tactile video.

16. The method of claim 15,
wherein the binary format for scenes includes a node including a url field that indicates the position of the tactile video, a startTime field that indicates a start time of the tactile video, and a stopTime field that indicates a stop time of the tactile video.

17. The method of claim 15, further comprising the step of:
(f) encoding and multiplexing the audiovisual media, the tactile video, and the binary format for scenes, thereby generating one file.

18. A computer readable recording medium in which a program for authoring tactile information by the method of claim 12 is stored.
